(19) United States
(12) Patent Application Publication
(10) Pub. No.: US 2007/0171499 A1
(43) Pub. Date: Jul. 26, 2007

(54) Reflective member

(76) Inventors: Austin McKinnon, Herriman, UT (US); Brett Mortensen, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/338,125

(22) Filed: Jan. 23, 2006

(51) Int. Cl. G02B 26/08

(52) U.S. Cl. 359/208; 359/216

(57) ABSTRACT

Example embodiments of a reflective member are illustrated and described.

### BACKGROUND

Optical scanning devices are often used to scan a pulsed beam of laser light across a photoconductor. Refractive optical elements, such as lenses, are sometimes used in such devices. These refractive optical elements may be expensive. Further, many optical scanning devices using such refractive optical elements have long laser beam paths and are, therefore, not compact.

### BRIEF DESCRIPTION OF THE DRAWINGS

FIG. 1 illustrates a schematic diagram of an example imaging device according to an example embodiment.

FIG. 2 illustrates a plan schematic of an example optical scanner according to an example embodiment.

FIG. 3 illustrates an elevation view of the FIG. 2 optical scanner according to an example embodiment.

FIG. 4 illustrates a portion of the FIG. 2 optical scanner according to an example embodiment.

FIG. 5 is a flowchart illustrating an example method according to an example embodiment.

FIG. 6 illustrates a portion of an example series of lines connected by nodes according to an example embodiment.

### DETAILED DESCRIPTION

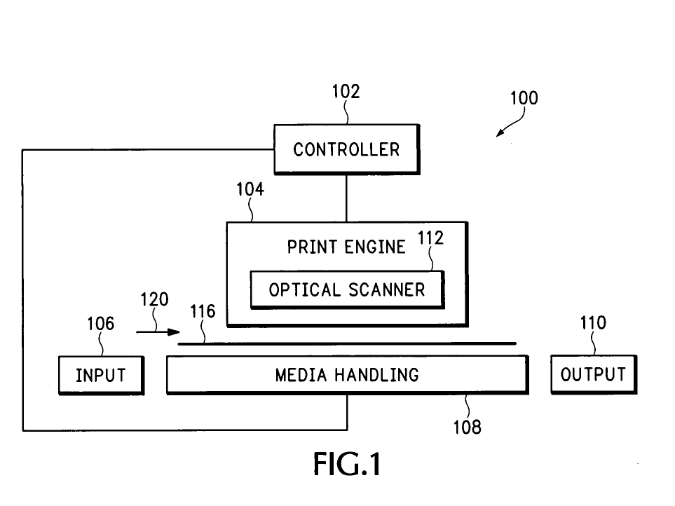

FIG. 1 illustrates an example embodiment of an imaging device 100. The imaging device 100 may be configured as a printer, a copier, or the like. In some embodiments, the imagine device 100 comprises a laser printer. The imaging device 100 is shown as including a controller 102, a print engine 104, an input 106, a media handling system 108, and an output 10. The print engine 104 includes an optical scanner 112.

Controller 102 comprises a processing unit configured to generate control signals directing the operation of the print engine 104, the optical scanner 112, and the media handling system 108.

For the purpose of this disclosure, the term “controller” shall include a conventionally known or future developed processing unit that executes sequences of instructions contained in a memory. Execution of the sequences of instructions causes the controller to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 102 is not limited to any specific combination of hardware circuitry and software, nor to any particular source for the instructions executed by the processing unit.

According to some embodiments, the imaging device 100 operates under control of the controller 102 and advances media, such as sheet 116, from the input 106 to the print engine 104 using the media handling system 108. The media handling system 108 is illustrated schematically in FIG. 1 and may comprise an arrangement of rollers, belts, or the like configured to advance media in the direction 120 from the input 106 to the print engine 104. The input 106 may comprise a bin or tray for storing media to be imaged by the print engine 104. The media handling system 108 is also configured to advance media, such as the sheet 116, from the print engine 104 to the output 110. The output 110 may comprise a bin or tray for storing media that has been printed upon by the print engine 104.

In some embodiments, the print engine 104 functions by scanning an electrostatic latent image onto a photoconductor (not shown in FIG. 1) using the optical scanner 112. The optical scanner 112 scans the latent image onto the photoconductor using a laser beam (not shown in FIG. 1) modulated by an input signal from the controller 102. In some embodiments, toner (not shown) is then passed over the photoconductor and electrostatically attracted to the latent image. The toner is then transferred to the media, such as the sheet 116, as the media passes the photoconductor. The toner may be fused to the media by a fuser (not shown).

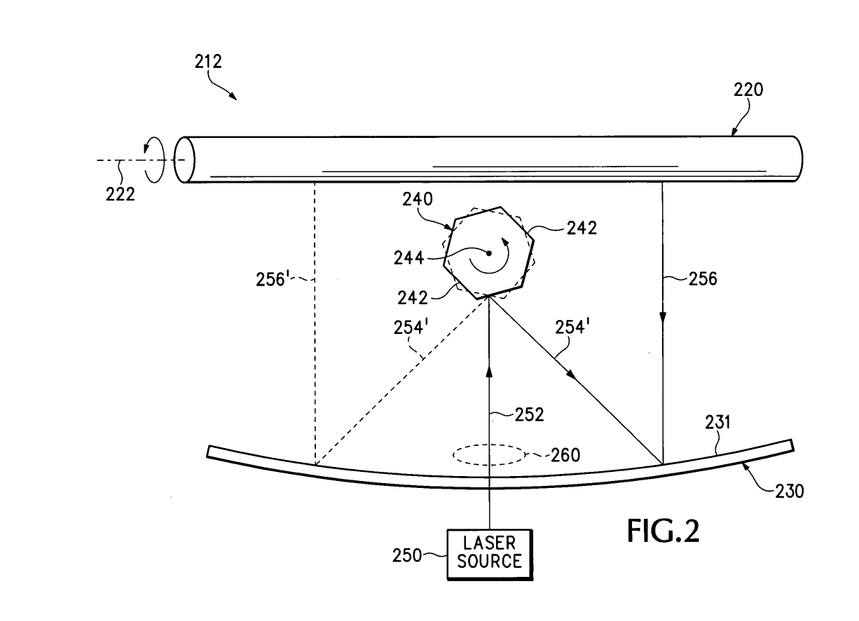

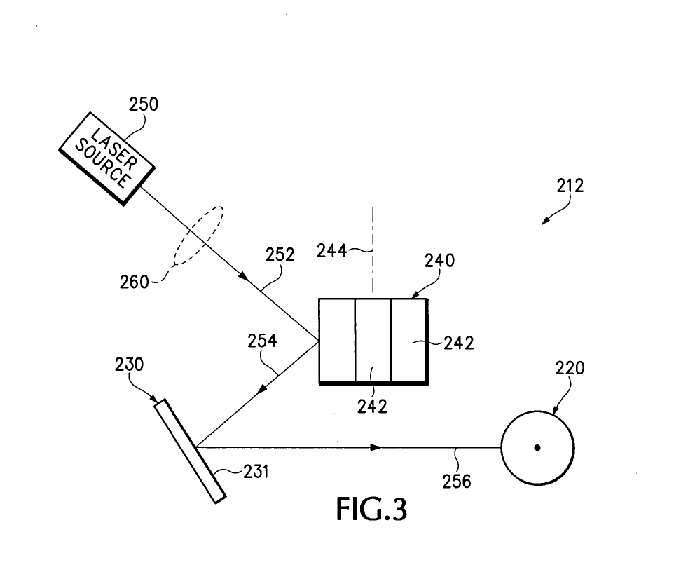

FIGS. 2 and 3 illustrate details of an example embodiment of an optical scanner 212. In some embodiments, the optical scanner 212 may be used as the optical scanner 112 shown in FIG. 1. Pursuant to other embodiments, the optical scanner 212 may be used in other environments and configurations.

The example optical scanner 212 shown in FIGS. 2 and 3 includes a photoconductor 220, a curved mirror 230, a polygonal mirror 240, and a laser source 250. In this embodiment, beam 252 generated at the laser source 250 passes to the polygonal mirror 240 and reflects from the polygonal mirror 240 and becomes beam 254. The beam 254 passes to the curved mirror 230. The beam 254 then reflects from the curved mirror 230 and becomes beam 256, which passes toward the photoconductor 220. As shown in FIGS. 2 and 3, neither of the beams 254 nor 256 passes through a refractive optical element or lens. Moreover, the laser beam undergoes a single reflection after reflecting from the polygonal mirror 240 and before striking the photoconductor 220.

The polygonal mirror 240 is shown as having six sides 242. The sides 242 in some embodiments may also be referred to as facets. The polygonal mirror 240 is configured to rotate about axis 244 at a high speed to turn the sides 242 across the beam 252. The polygonal mirror 240 may be rotated by a motor (not shown).

The laser source 250 is configured to generate the beam 250. The laser source 250, in some embodiments, comprises a laser diode laser source or other suitable laser source. The laser source 250 may operate under control of the controller 102 to generate pulsed laser light.

The photoconductor 220 comprises a photoconductive surface that may be discharged by light applied to the surface of the photoconductor 220. In the embodiment shown in FIGS. 2 and 3, the photoconductor 220 comprises a photoconductive drum. Pursuant to other embodiments, the photoconductor 220 may comprise a photoconductive belt or other suitable photoconductive structure.

The curved mirror 230 comprises a reflective surface 231 configured to reflect light from the polygonal mirror 240 toward the photoconductor 220. In some embodiments, the curved mirror 230 may comprise a first surface mirror. As shown, the beam 256 passes toward the photoconductor 220 in a direction orthogonal to the photoconductor. In some embodiments, the beam 256 is orthogonal to the axis of rotation 222 of the drum 220. Maintaining the beam 256 orthogonal to the photoconductor 220 may provide a satisfactory quantity of light energy absorbed by the photoconductor.

Some embodiments, the combined length of the beams 252, 254, 256 may be reduced by the compact arrangement of the curved mirror 230, the polygonal mirror 240 and the photoconductor 220. It should be noted that in some embodiments, the beam 256 is not orthogonal to the photoconductor 220 or the axis of rotation 222. Indeed, the curvature of the curved mirror 230 may alternatively be shaped for providing a compact design, to have substantially constant dot velocity across the photoconductor, or the like.

FIG. 2 also illustrates the polygonal mirror 240 in a rotated position in dashed lines. In the rotated position shown in dashed lines in FIG. 2, the polygonal mirror 240 reflects beam 252 as beam 254′ (shown in dashed lines) and the curved mirror 230 reflects the beam 254′ (shown in dashed lines) as beam 256′ (shown in dashed lines). It should be noted that the beam 256′ is orthogonal to the photoconductor 220 even though the point at which the beam 256′ is incident on the surface 231 of the curved mirror 230 is different from the point at which the beam 256 is incident on the surface 231 of the curved mirror 230.

In some embodiments, therefore, a single curved mirror 230 is used to direct a laser beam from a polygonal mirror 240 to a photoconductor 220. The surface 231 of curved mirror 230 is not subject to definition by single order polynomial. In some embodiments, the surface 231 of the curved mirror 230 is not subject to definition by less than about a 6^{th} order polynomial. In still other embodiments, the surface 231 of curved mirror 230 is not defined by a finite order polynomial. Pursuant to some embodiments, the surface 231 of the curved mirror 230 may be reasonably approximated by a 6^{th} order or higher polynomial.

In some embodiments, the beam 252 has a diameter of about 0.0233 inches (0.59182 millimeters). Pursuant to other embodiments other diameters may be employed. In configurations where optical distortion of the beams 252, 254, 256 is greater than desired, a small, fixed lens 260 (shown in dashed lines) may be positioned along the path of beam 252 between the laser source 250 and the polygonal mirror 240. The lens 260 may be omitted in some embodiments. Use of the lens 260 may result in a smaller spot size of the beam 256 at the photoconductor 220.

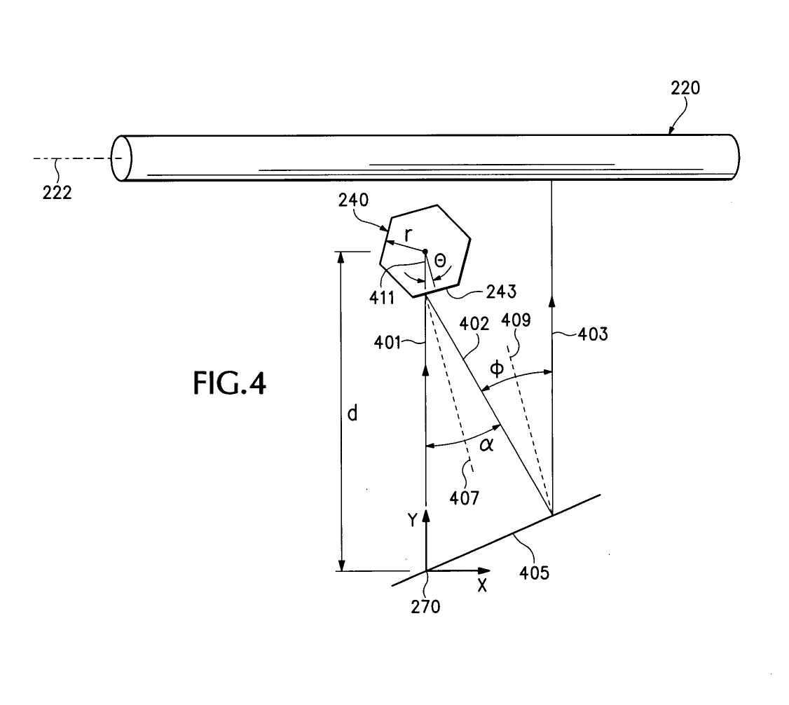

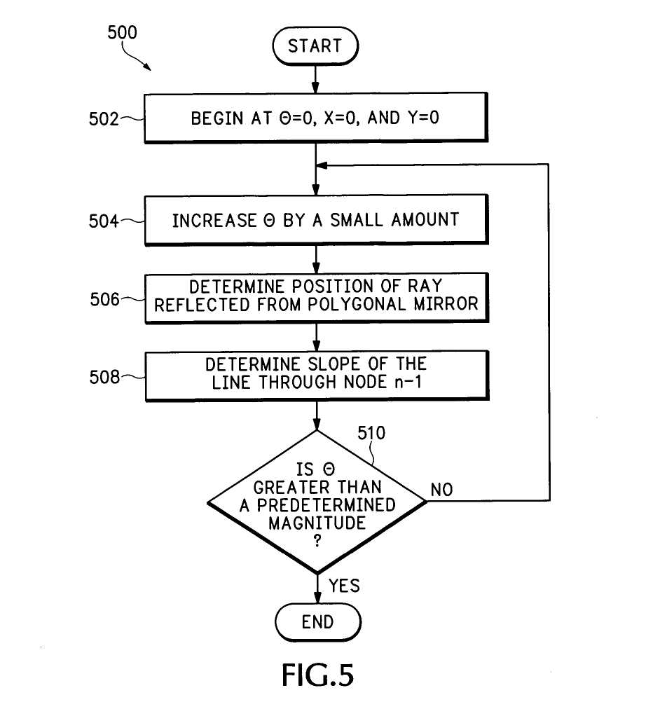

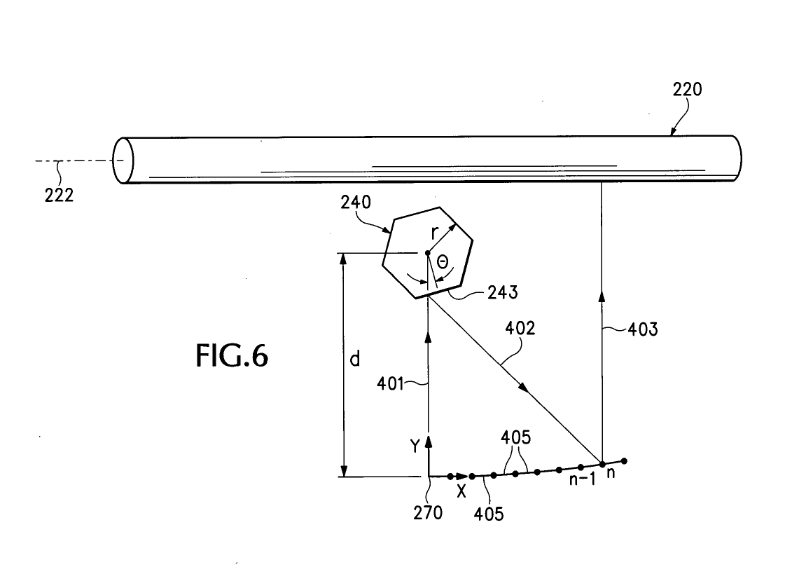

An example numerical method for determining the shape, or curvature, of the surface 231 of the curved mirror 230 will now be discussed with reference to FIGS. 4 and 5. Embodiments of this method may be employed to provide for a beam oriented orthogonal to the photoconductor. FIG. 4 schematically illustrates the photoconductor 220 and the polygonal mirror 240 and origin 270. FIG. 5 illustrates flowchart 500. In some embodiments, the shape of the curved mirror 230 is determined via a numerical method. An example numerical method for determining the shape of the surface 231 of the curved mirror 230 is provided. This is an iterative numerical method. FIG. 6 illustrates a portion of an example series of lines connected by nodes according to an example embodiment of the method described with reference to FIG. 5.

The method begins at block 502 by starting with θ=0, x=0, and y=0. The angle θ represents the angle of rotation of the polygonal mirror from a reference position 411. The x and y directions are shown in FIG. 4.

Next, pursuant to block 504, the angle θ is increased a small, incremental amount. Increasing the angle θ causes ray 401 to be reflected from surface 243 as ray 402. The small amount by which the angle θ is increased may be different in different embodiments. In some embodiments, the amount by which the angle θ is increases may be in the range of about 0.1-0.0006 degrees. Pursuant to some example embodiments, the amount by which the angle θ is increased should be less than about 0.001 degrees.

Next, pursuant to block 506, the position of a line coincident with ray 402 is calculated. The position of the line coincident with ray 402 may include determining or calculating the equation of that line. In some embodiments, the form of the equation may be the slope-intercept form y=mx+b, where m is the slope of the line, and b is the y-axis intercept of the line. The form of the equation of the line may, of course, take different forms. The position of the line coincident with the ray 402 may be determined by determining the position of a line that forms an angle a with ray 401 such that the angle α is bisected by a line 407 that is perpendicular to the side 243 of the polygonal mirror 240.

Next, pursuant to block 508, the slope of line 405 through node n−1 is calculated such that the reflected ray 403 is orthogonal to the photoconductor 220. Initially, the node n−1 is the origin 270. The line 405 passes through the node n−1 and has a slope such that a line 409 perpendicular to the line 405 bisects an angle Φ formed between the reflected ray 403 and the line 402 and where the reflected ray 403 is orthogonal to the photoconductor 220. In this configuration, the reflected ray 403 is also orthogonal to the axis of rotation 222 of the photoconductor 220. The endpoint of the line 405, at which the ray 402 intersects the ray 403 becomes the new point n−1. In the FIGS., the size of the angle θ and the length of the line 405 are enlarged for ease of illustration and clarity.

Next, at block 510, it is determined whether the magnitude of the angle θ is greater than a predetermined magnitude. If the magnitude of the angle θ is greater than the predetermined magnitude, the process ends, else, execution returns to block 504. The predetermined magnitude used in the block 510 can vary. In some embodiments, this magnitude is sufficiently large that the x-dimension of the n−1 node is close to the x-dimension of an end of the photoconductor 220.

As this process proceeds multiple lines 405 are generated. The slope of each of the lines 405 depends on the associated angle θ. FIG. 6 illustrates an example of the curved surface determined by the method described above and illustrated in FIGS. 4, 5. As shown in FIG. 6, multiple nodes are illustrated as connecting multiple lines 405. This process is illustrated for the right-hand half of the curved surface. The left-hand side of the curved surface may be formed such that the left-hand side of the curved surface is symmetrical and has even symmetry with the right-hand side of the curved surface. Alternatively, lines 405 for the left-hand side of the curved surface may be calculated by using the method described above modified by decrementing the angle θ by a small amount in block 504 instead of increasing the angle θ by a small amount.

As shown in some of the FIGS. the dimension r of the polygonal mirror is about 0.5 inches (1.27 cm) and the dimension d is about 3 inches (7.62 cm). These are example, non-limiting dimensions. Other dimensions may, of course, be employed.

Pursuant to some configurations, the speed at which the beam traverses the photoconductor may vary. In particular, the beam may move faster near the ends of the photoconductor than the middle of the photoconductor. As such, to compensate, the speed or rate at which the beam is pulsed may be varied.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus, comprising:
a photoconductor;
a mirror; and
a curved reflective member configured to reflect a beam of light from the mirror to the photoconductor in a direction orthogonal to the photoconductor.

2. The apparatus of claim 1, wherein the curved reflective member is a first surface mirror.

3. The apparatus of claim 1, wherein the curved reflective member is defined by at least a 6th-order polynomial.

4. The apparatus of claim 1, wherein the light beam traverses a path between the mirror and the curved reflective member free from any lens.

5. The apparatus of claim 1, wherein the light beam only traverses an air medium between the curved reflective surface and the photoconductor.

6. The apparatus of claim 1, wherein the beam of light passes through a lens before reflecting from the mirror.

7. The apparatus of claim 1, wherein the mirror comprises a rotatable polygonal mirror.

8. The apparatus of claim 1, wherein the photoconductor comprises a photoconductive drum.

9. The apparatus of claim 1, wherein a curved profile of the curved reflective member is determined by an iterative numerical method.

10. An apparatus, comprising:
a photoconductive member; and
an arcuate reflective surface configured to reflect a beam of light from a mirror directly to the photoconductive member.

11. The apparatus of claim 10, wherein the arcuate reflective surface is a first-surface mirror.

12. The apparatus of claim 10, wherein the mirror is a rotatable polygonal mirror.

13. The apparatus of claim 10, further comprising:
a laser source; and
a lens positioned between the laser source and the mirror.

14. The apparatus of claim 10, wherein the arcuate reflective surface is further configured to reflect a beam of light from the mirror at an angle orthogonal to the photoconductive member.

15. The apparatus of claim 10, wherein the arcuate reflective surface is further configured to reflect the beam of light from the mirror at an angle orthogonal to the photoconductive member as the mirror rotates

16. A print engine, comprising:
a photoconductor;
a laser source for generating a beam of light;
a rotatable polygonal mirror positioned such that the beam of light from the laser source is incident at rotatable polygonal mirror;
a curved mirror configured to reflect a beam of light from the rotatable polygonal mirror directly to the photoconductor.

17. The print engine of claim 16, wherein the curved mirror is further configured to reflect the beam of light from the rotatable polygonal mirror in a direction orthogonal to the photoconductor.

18. The print engine of claim 16, wherein the curved mirror is further configured to reflect the beam of light from a concave surface.

19. The print engine of claim 16, wherein the curved mirror is further configured to reflect the beam of light from a reflective surface, the reflective surface being at least a 6^{th} order surface.
